(19) United States
(12) Patent Application Publication
(10) Pub. No.: US 2014/0088921 A1
(43) Pub. Date: Mar. 27, 2014

(54) NON-DESTRUCTIVE TESTING INSTRUMENT WITH DISPLAY FEATURES INDICATING SIGNAL SATURATION

(71) Applicants: Hanan Hayot, Newton, MA (US); Marc Dulac, Dracut, MA (US)

(72) Inventors: Hanan Hayot, Newton, MA (US); Marc Dulac, Dracut, MA (US)

(73) Assignee: OLYMPUS NDT, INC., Waltham, MA (US)

(21) Appl. No.: 14/035,202

(22) Filed: Sep. 24, 2013

Related U.S. Application Data
(60) Provisional application No. 61/705,361, filed on Sep. 25, 2012.

(51) Int. Cl. G01D 7/00

(52) U.S. Cl. CPC G01D 7/00
USPC 702/189

(57) ABSTRACT

Disclosed is a non-destructive testing instrument configured, when the digital signal is saturated during one data acquisition session, to display an indicator flag to warn the operator in order to help the operator to clearly see that a measurement is invalid. It's also configured to abandon and not to display the measurement results to stop any further analysis on them.

### CROSS-REFERENCE TO RELATED APPLICATIONS

This application claims the benefit and priority of U.S. Provisional patent application Ser. No. 61705361 filed Sep. 25, 2012 entitled A NON-DESTRUCTIVE TESTING INSTRUMENT WITH DISPLAY FEATURES INDICATING SIGNAL SATURATION, the entire disclosure of which is incorporated herein by reference.

### FIELD OF THE INVENTION

The present invention relates to a non-destructive testing instrument configured for performing measurement on a test object and providing measurement results, more particularly to a non-destructive testing instrument that displays an indication to the user that a signal is saturated.

### BACKGROUND OF THE INVENTION

A clean, non-saturated, ultrasonic signal received in non-destructive testing is essential to achieve accurate measurement results when using an ultrasonic instrument. This is especially true for precision thickness gauge instruments. The thickness gauge is designed to receive and measure an ultrasonic echo with predefined maximum amplitude. If the amplitude of the ultrasonic echo exceeds the maximum amplitude that the gauge can receive it will produce an invalid thickness measurement. However, often the user is not made aware of such invalid measurements by using existing instruments, since the displayed received signal is filtered and saturation is not apparently shown, causing an incorrect analysis of a sample or a target

U.S. Pat. No. 8,001,841 by Thomas discloses an apparatus that, in part, aims to address the aforementioned drawbacks. The apparatus detects saturation in each channel in a wide dynamic system where echo signal is split and processed in parallel channels. It provides a mechanism to select the least saturated channel(s) when re-composing digitized data. It also provides a mechanism to minimize the saturation after an overflow is detected. However, it fails to provide the instrument operator an indication, such as a “flag” display, when the whole system, not just a few channels, is saturated during the thickness measurement.

U.S. Pat. No. 7,958,796 B2 by Langlois et al. discloses a method that provides detection of channel saturation in phased array ultrasonic non-destructive testing. However, it does not provide a method of discontinuing the data processing and measurement results display; it neither provides an indication flag on the display to the instrument operator upon encountering saturation.

### SUMMARY OF THE INVENTION

It is an objective of the present invention to provide an indication flag on the display to alert the operator when saturation occurs for ultrasonic instruments, such as thickness gauges.

It is another objective of the present invention to stop the saturated front-end (analog) data from being further processed, and to blackout displaying of any measurement data so that no invalid data is read mistakenly.

Many advantages can be made available by using the novel design as presently disclosed. Most prominently, it helps operator to clearly see that a measurement is invalid and therefore not to mistakenly make any thickness analysis based on the saturated data.

Advantages provided by the present disclosure also include that it allows the instrument to recover much faster without processing saturated signal and therefore to be ready for next cycle of pulsing.

### BRIEF DESCRIPTION OF THE DRAWING(S)

FIGS. 1a and 1b are diagrams showing how the saturated and non-saturated signals are displayed or blocked-out, respectively, according of the preferred embodiment of the present invention.

FIG. 2 is a flow chart of functional steps or modules included in the process of providing an alarm and blocking the measurement display upon saturation according to the present invention.

FIG. 3 is a flow chart of functional steps or modules included in a process of providing an alarm and blocking the measurement display upon saturation with an auto correction module according to an alternate embodiment of the present invention.

FIG. 4 is flow chart providing an elaboration for the process of the measurement disabling module according to the preferred embodiment of the present invention.

### DETAILED DESCRIPTION OF PREFERRED EMBODIMENT

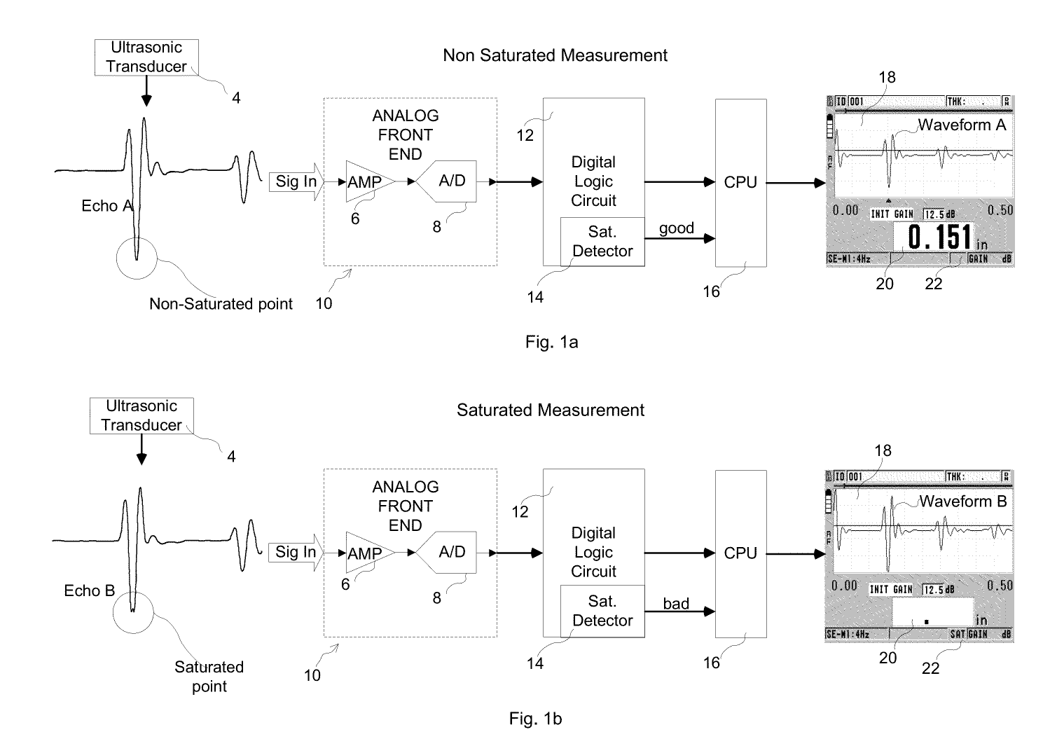

Referring to FIGS. 1a and 1b, which show how the non-saturated and saturated signals are displayed or blacked-out for display, according to the preferred embodiment of the present invention. The non-destructive testing instrument, which is configured to perform measurements on a test object and provide measurement results, comprises an ultrasonic transducer 4, a data acquisition unit 10, which further comprises an amplifier 6 and an analog to digital (A/D) converter 8, a digital logic circuit 12, within which there is a saturation detector 14, a processor 16, a waveform window 18, a measurement value window 20 and a saturation indicator flag 22. During a data acquisition session, transducer 4 is energized with an ultrasonic pulse and receives an echo signal which later amplified and converted to digital signal by A/D converter 8.

In FIG. 1a, showing the case of a non-saturated scenario, an ultrasonic echo A from transducer 4 is fed into data acquisition unit 10, where the ultrasonic echo A is amplified by amplifier 6 with a predetermined gain and then sampled by analog to digital converter 8. Digital logic circuit 12 processes the sampled data and saturation detector 14 detects if the measured signal is saturated. If the processed measurement data is valid or not saturated, as in this case, processor 16 allows a numeric thickness measurement value to be displayed in measurement value window 20 as the received ultrasonic waveform A is displayed on waveform window 18. Also processor 16 does not display saturation indicator flag 22 since the data was not saturated.

It should be noted that there are many methods used in existing practice that can detect such saturation. For example, many A/D converters themselves have the capability of flagging for an overflown incidence. U.S. Pat. Nos. 8,001,841 and 8,001,842, which share the same ownership with the present application, have also disclosed methods of detecting saturation. The scope of the present disclosure, however, focuses on how to utilize the saturation indication and to alert and how to treat the already acquired measurement data after saturation is detected, not on how to detect such saturation.

It is known that a saturated signal denotes to the situation when the amplitude of the echo signal is larger than what the instrument's specification allows. For illustrative purpose, echo B is saturated versus echo A is not. One can see that echo signal B in FIG. 1b has a “flattened” tip versus a fully shown tip in echo A.

FIG. 1b shows the process when a saturated echo signal is received from transducer 4. Similar to the process shown in FIG. 1a, the echo signal is fed into data acquisition unit 10 where it is amplified by amplifier 6 with a predetermined gain and then sampled by analog to digital converter 8. This sampled data is then processed by digital logic circuit 12 and saturation detector 14 detects if the measured signal is saturated. In this case the measured signal is saturated and processor 16 blocks out the numeric measurement value shown in measurement value window 20 and displays a saturation indicator flag 22 in red (not shown) as the received ultrasonic waveform B is displayed on waveform window 18.

As can be seen, saturated measurement is hard to detect by the instrument operator by merely looking at the waveform display in waveform window 18. The difference in waveform A and waveform B in FIGS. 1a and 1b respectively, is hardly noticeable. This is because the saturated signal is filtered and saturation is not clearly shown on the waveform window 18. Therefore, only very experienced and alert operator is able to catch that the measurement is saturated and therefore should be discarded.

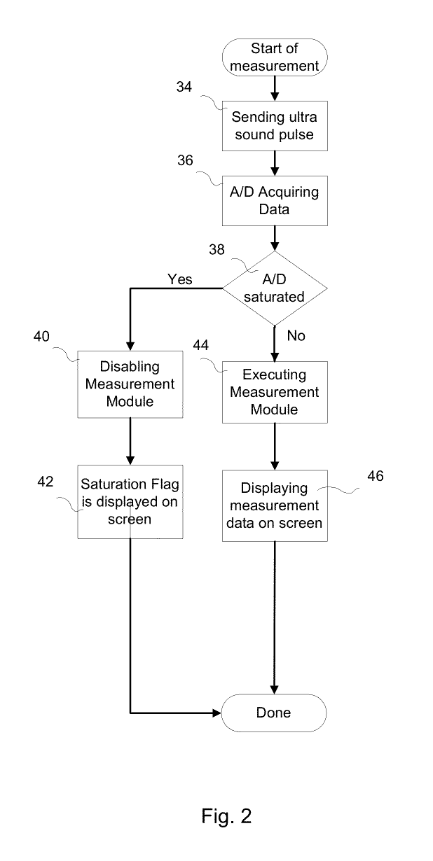

Reference is now made to FIG. 2, which is a flow chart of the functional steps or modules included in the process of providing an alarm and blocking the measurement display upon saturation according to the present invention. It should be noted that reference to FIGS. 1a and 1b still continues. In step 34, an ultrasonic pulse is sent to the sample through transducer 4. In step 36, analog to digital converter 8 samples the received echo from transducer 4, which has been amplified by amplifier 6. In step 38, digital logic circuit 12 processes the data and saturation detector 14, within digital logic circuit 12, checks if the received signal is saturated. In the case where there is no saturation, the process goes on to step 44, in which processor 16 processes the data, and step 46, in which processor 16 displays a thickness measurement and a normal signal waveform, as shown in Fig. la, in measurement value window 20 and waveform window 18.

In the case where there is saturation (“yes” route at check step 38), a disabling measurement module 40 is activated. As a result, the measurement result is blacked-out as shown in measurement value window 20 in FIG. 1b. Further following the “yes” route, in step 42 a saturation indicator flag 22 is displayed as shown in FIG. 1b.

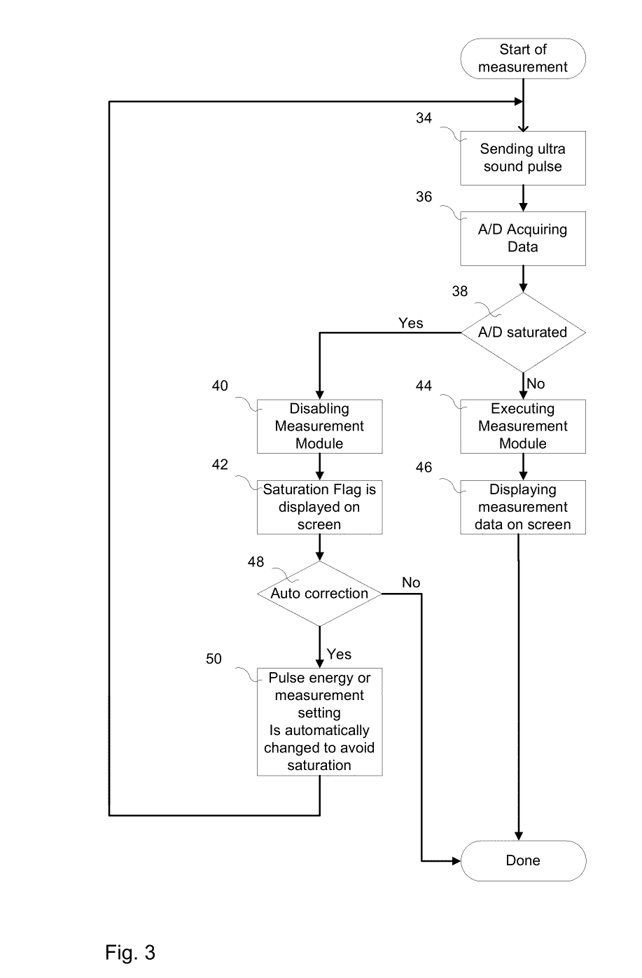

Referring to FIG. 3, an alternate embodiment is shown to introduce an auto correction capability when saturation is detected in step 38 in FIG. 2 (i.e. the “yes” route). It should be noted that information related to FIG. 3 is complimentary to FIG. 2.

As shown in FIG. 3, after disabling measurement module 40 is activated, step 42 displays a saturation indicator flag 22 as shown in FIG. 1. In the preferred embodiment, as seen in FIG. 2, the process would now be completed, but in this alternative embodiment the process continues with step 48.

It can be understood that in order to facilitate the following alternative steps, the instrument further includes an actuator, in the form of a touch screen button, a screen prompted selection step, or an actual button (not shown), to allow operator to choose whether an auto correction of the saturation is designed.

In step 48, processor 16 checks if the auto correction is turned on. When auto correction is on, in step 50, processor 16 adjusts the pulse energy and/or setting until the saturation indicator flag 22 is removed, as shown in FIG. 1a. If the auto-correction module is turned off in step 48, the saturation indication system works as described in the preferred embodiment.

The adjustment of pulse energy after instrument encounters saturation has been done manually in the existing practice by adjusting “one-notch down” within predetermined levels of pulse settings. The automatic adjustment is preferably designed to automatically adjust the instrument one pulse setting down, until the signal is not saturated. Whether adjusting one pulse-setting or multiple pulse-setting down, the present invention is not limited in this regard. It should be known to those skilled in the art that adjusting or turn down the pulse-setting usually involves selecting a higher attenuation for the instrument.

As seen in FIG. 3, after the pulse energy is adjusted at step 50, the auto-correction process can optionally re-start the process from step 34 to see the auto-corrected instrument pulse setting still causes signal being saturated or it is good to provided non-saturated measurement data.

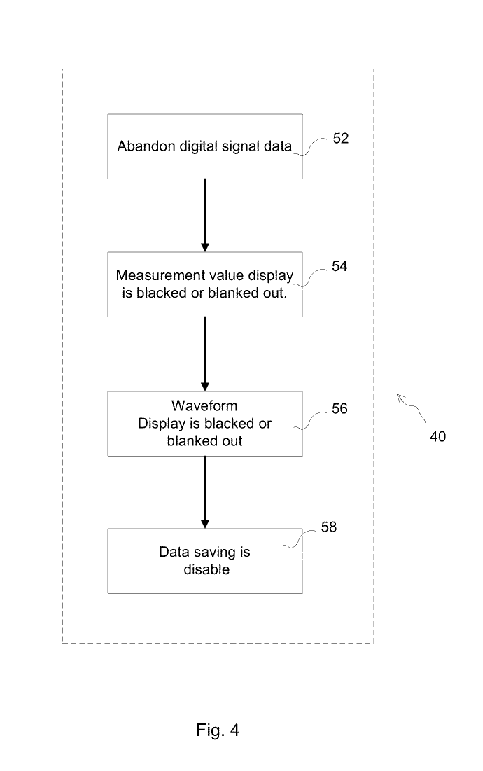

Reference is now made FIG. 4, which provides elaboration for disabling measurement module 40 in FIGS. 2 and 3. When the received signal is saturated, in step 52 the data acquisition session is aborted with digital signal blocked from going further. In step 54 the measurement data, i.e., the thickness measurement value display is blacked or blanked out from window 20. In step 56 the saturated waveform can be optionally displayed or blacked/blanked out. It should be noted that the waveform data and the measurement value data can be treated separately, if one desires. One can choose to abandon the measurement value data, but still allow the waveform data to go through in order to display the saturated waveform. Both of the options are within the scope of the present disclosure. In step 58, data saving is disabled so the saturated data is not recorded. Then functional steps or modules of FIGS. 2 and 3 continue with step 42, where saturation indicator flag 22 is displayed on the screen and then with the rest of the steps found in FIGS. 2 and 3.

Although the present invention has been described in relation to particular exemplary embodiments thereof, many other variations and modifications and other uses will become apparent to those skilled in the art. It is preferred, therefore, that the present invention not be limited by the specific disclosure. For example, the scope of the present disclosure may be applied to a wide range of NDT/NDI instruments related to many technologies, such as, but not limited to Eddy Current, Bond Testing, Hall-Effect (Magnetic), single element or multi-element ultrasonic testing.

What is claimed is:

1. A non-destructive testing instrument configured for performing measurement on a test object and providing measurement results, comprising,
a probe sending a testing energy into the test object and receiving an echo signal from the test object during a data acquisition session;
a data acquisition unit receiving and converting said echo signal to digital signal, for the data acquisition session;
a display viewing unit;
a digital logic and processing unit detecting said digital signal to be either saturated or non-saturated for the data acquisition session, and processing said digital signal and for displaying the measurement results on the viewing unit when the digital signal is non-saturated; whereas providing and causing to display an alert flag on the viewing unit, and further causing an abandonment of the digital signal so that the measurement results for the acquisition session are not displayed on the viewing unit.

2. The instrument of claim 1, wherein the viewing unit comprises a waveform display area for display of waveform, and a measurement value display area.

3. The instrument of claim 1, wherein the digital logic and processing unit further comprises a saturation detector configured for detecting the digital signal to be either saturated or non-saturated.

4. The instrument of claim 1, wherein the digital logic and processing unit further comprises a disabling measurement module configured to cause the abandonment of the digital signal for the data acquisition session when the signal is saturated.

5. The instrument of claim 1, wherein the digital logic and processing unit further comprises a saturation flagging module configured to provide and cause to display an alert flag on the viewing unit.

6. The instrument of claim 1, wherein the digital logic and processing unit further comprises an actuator allowing an operator to turn on auto correction of digital signal when the digital signal is saturated.

7. The instrument of claim 6, the digital logic and processing unit further comprises a module to automatically adjust down measurement pulse setting when the digital signal is saturated and when the auto correction is turned on.

8. The instrument of claim 2, wherein the digital logic and processing unit is further configured to perform at least one of the following when the digital signal is saturated:
a) blacking/blanking out the measurement value display area;
b) blacking/blanking out the waveform display area;
c) not saving digital signal of the acquisition session.

9. A method of alerting and blocking a saturated data acquisition session in a non-destructive testing instrument, the instrument is configured for performing measurement on a test object and providing measurement results,
the method comprises steps of:
sending exciting testing energy into the test object and receiving an echo signal from the test object during a data acquisition session;
receiving and converting said echo signal to digital signal, for the data acquisition session;
detecting the digital signal of being saturated or not being saturated;
displaying a waveform and/or measurement value pertaining to the digital signals of the acquisition session if the digital signal is not saturated;
displaying a warning if the digital signal is saturated, and blocking display of the waveform and/or measurement value when the digital signal is saturated if the digital signal is saturated.

10. The method of claim 9, wherein the step blocking display further comprises abandoning digital data and not saving the digital data.

11. The method of claim 9, wherein the step of blocking display further comprises the steps of blanking or blacking out the display of the waveform and the measurement value for the data acquisition session.

12. The method of claim 9 further including a step of automatically adjusting measurement gain setting of the instrument if the digital signal is saturated.

13. The method of claim 9, wherein the step of displaying a warning including displaying a warning flag.
